(19) United States
(12) Patent Application Publication
(10) Pub. No.: US 2008/0070732 A1
(43) Pub. Date: Mar. 20, 2008

(54) GEMINI CHAIN SYSTEM WITH RESONANCE ELIMINATION FEATURE

(75) Inventor: Timothy J. Ledvina, Groton, NY (US)

Correspondence Address: BORGWARNER INC.;c/o Brown & Michaels, PC, 400 M&T Bank Building, 118 N. Tioga Street, Ithaca, NY, 14850, US

(73) Assignee: BORGWARNER INC., Auburn Hills, MI (US)

(21) Appl. No.: 11/853,138

(22) Filed: Sep. 11, 2007

Related U.S. Application Data
(60) Provisional application No. 60/826,320, filed on Sep. 20, 2006.

(51) Int. Cl. F16G 13/02

(52) U.S. Cl. 474/206

(57) ABSTRACT

An extension from an element of a first chain contacts a second chain in a phased chain system such that the extension reduces resonance of the second chain. Preferably, an extension from an element of the second chain contacts the first chain to reduce resonance in the first chain. The extension snubs the motion of the mating chain to inhibit resonance. The extensions are preferably integral with their respective elements. In one embodiment, the extension extends from a guide link plate. In another embodiment, the extension extends from an inverted tooth link plate. In yet another embodiment, the extension extends from a pin. In a preferred embodiment, the extension extends at an angle to provide a slight preload with the adjacent chain. The elements having extensions are preferably randomly located along the chains. The first chain and the second chain are preferably inverted tooth chains.

### REFERENCE TO RELATED APPLICATIONS

This application claims one or more inventions which were disclosed in Provisional Application No. 60/826,320, filed Sep. 20, 2006, entitled “GEMINI CHAIN SYSTEM WITH RESONANCE ELIMINATION FEATURE”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of multi-chain assemblies. More particularly, the invention pertains to a multi-chain assembly with lateral extensions for resonance reduction.

2. Description of Related Art

Phased chain assemblies are known in the art. U.S. Pat. No. 5,427,580, “Phased Chain Assemblies”, Ledvina et al., issued Jun. 27, 1995, discloses a phased chain and sprocket assembly including a sprocket having at least two rows of teeth with a phase angle between the rows of teeth. The phased chain alternately engages the rows of sprocket teeth during operation of the assembly. The phased chain assembly is part of a chain-drive system used in an automotive front-wheel drive transmission. An advantage of the phased assembly is reduced noise during operation.

A sprocket for a phased chain assembly has at least two rows of teeth typically with at least one set being out of phase. The sprocket 10 of FIG. 1 is split into three portions 12, 14, 16 which are offset by one-half tooth space, while the sprocket 20 of FIG. 2 is split into two portions 22, 24, which are phased or offset by one-half tooth space. Alternatively, the portions of the three-portion sprocket 10 may be offset by one-third tooth space for each section of the sprocket. The chain assembly is utilized to drive, for example, an engine timing assembly including a camshaft and crankshaft, or a transfer case for a four-wheel drive vehicle. The sprockets are mounted on the shafts and allow power transfer between the chain and the two shafts.

Many different chain designs and lacings are known in the art for use in a phased chain assembly. In FIG. 3, the pins 30, 32 of the two separate chain assemblies 34, 36 are offset by a half pitch. In FIG. 4 the pins 40, 42 of the inverted tooth chains 44, 46 are offset and nested.

U.S. Pat. No. 6,106,425 shows an assembly of two phased chains held together by clips to form one composite chain assembly. The clips are rotatably fitted to the chain pins to allow articulation of the two chains independent of one another. This feature does not prevent transverse motion of one chain strand relative to the other. Furthermore, assembly of the clips between the insides of the two chains is highly impractical if the clips contain a closed aperture.

Struts for phased chain assemblies for continuously variable transmissions are known in the art. U.S. Pat. No. 5,453,058 and U.S. Pat. No. 5,645,502 show struts held between pairs of toes on inner links in phased chain assemblies. Each strut is held by multiple inner links. The struts extend substantially across the entire width of the chain assemblies and are located on the front pulley-contacting side of the chain. The struts contact the sheaves of the pulley to transmit power between the pulley and the chain.

Publication No. JP2-76944 discloses a power transmission device. In one embodiment of a phased silent chain assembly, a pin from the first chain extends and is coupled to a link of the second chain such that the chains cannot disengage from each other. A bushing covers part of the pin to maintain a distance between the two chains.

Resonance in chain and sprocket assemblies produces noise and increases wear on the chain. Prior art chains contain design features to control resonance that have worked with varying degrees of success. Links have been designed to prevent backbending as a means of controlling resonance. This has been effective in systems having short center distances where little chain wear has taken place. However, as the chain wears, the links move apart, allowing an increasing amount of backbending to occur. Eventually, the backbending becomes great enough that resonance is no longer prevented.

Spring links have also been used to prevent resonance by increasing the friction in the chain. This strategy may be effective to control resonance, but the added chain friction is undesirable in that it reduces the efficiency of the chain drive.

Fixed chain guides are also known in the art to control chain resonance. Fixed chain guides require, however, some method of attachment to be retained in the proper position by an additional part in the chain drive, which adds to production cost.

There is a need in the art for a chain design feature for a phased chain assembly to control resonance that is inexpensive, does not reduce chain performance, and remains effective for the lifetime of the chain.

### SUMMARY OF THE INVENTION

An extension from an element of a first chain contacts a second chain in a phased chain system such that the extension reduces resonance of the second chain. Preferably, an extension from an element of the second chain contacts the first chain to reduce resonance in the first chain. The extension snubs the motion of the mating chain to inhibit resonance. The extensions are preferably integral with their respective elements. In one embodiment, the extension extends from a guide link plate. In another embodiment, the extension extends from an inverted tooth link plate. In yet another embodiment, the extension extends from a pin. In a preferred embodiment, the extension extends at an angle to provide a slight preload with the adjacent chain. The elements having extensions are preferably randomly located along the chains. The first chain and the second chain are preferably inverted tooth chains.

In one embodiment, the chain and sprocket assembly includes a drive sprocket assembly, a driven sprocket assembly, a first chain assembly, and a second chain assembly. The drive sprocket assembly has a plurality of first drive sprocket teeth and a plurality of second drive sprocket teeth. The first drive sprocket teeth and the second drive sprocket teeth are disposed in a parallel relationship and connected to a drive shaft to turn with the drive shaft. The driven sprocket assembly has a plurality of first driven sprocket teeth and a plurality of second driven sprocket teeth. The first driven sprocket teeth and the second driven sprocket teeth are disposed in a parallel relationship and connected to a driven shaft to turn with the driven shaft. The first chain assembly connects the first drive sprocket teeth and the first driven sprocket teeth. The first chain assembly includes a plurality of interleaved sets of first links including a plurality of first elements. The first elements include a plurality of first link plates and a plurality of first pins holding the first link plates together. The first link plates have apertures for receiving the first pins. The second chain assembly connects the second drive sprocket teeth and the second driven sprocket teeth. The second chain assembly includes a plurality of interleaved sets of second links including a plurality of second elements. The second elements include a plurality of second link plates and a plurality of second pins holding the second link plates together. The second link plates have apertures for receiving the second pins. At least one of the first elements is a damping first element including a first extension extending from a first element body such that the first extension contacts a back surface of the second chain assembly by inhibiting movement of the second chain in an first direction to reduce resonance in the second chain assembly during operation of the chain and sprocket assembly. The first extension allows movement of the second chain in a second direction opposite the first direction.

In a second embodiment, the first chain assembly includes a plurality of interleaved sets of first links including a plurality of first link plates held together by a plurality of first pins. The first link plates have apertures for receiving the first pins. The second chain assembly includes a plurality of interleaved sets of second links including a plurality of second link plates held together by a plurality of second pins. The second link plates have apertures for receiving the second pins. The first link plates include at least one tabbed first link plate. The first link plate includes a first link plate body and a first tab extending from the first link plate body such that the first tab contacts the second chain assembly to reduce resonance in the second chain assembly during operation of the chain and sprocket assembly.

In a third embodiment, the first chain assembly for a chain and sprocket assembly includes a plurality of interleaved sets of first links. The sets of first links include a plurality of first elements. The first elements include a plurality of first link plates and a plurality of first pins holding the first link plates together. The first link plates have apertures for receiving the first pins. At least one of the first elements is a damping first element including a first extension extending from a first element body. During operation of the chain and sprocket assembly, the first extension contacts a back surface of a second chain assembly to reduce resonance in the second chain assembly by inhibiting movement of the second chain in a first direction. The first extension permits the second chain to move in a second direction opposite the first direction.

In a fourth embodiment, the first chain assembly for a chain and sprocket assembly includes a plurality of interleaved sets of first links. The sets of first links includes a plurality of first link plates held together by a plurality of first pins. The first link plates have apertures for receiving the first pins. The first link plates include at least one tabbed first link plate including a first link plate body and a first tab extending laterally from the first link plate body of the first chain assembly.

### BRIEF DESCRIPTION OF THE DRAWINGS

FIG. 1 shows a prior art triple-toothed sprocket.

FIG. 2 shows a prior art double-toothed sprocket.

FIG. 3 shows two prior art offset silent chains.

FIG. 4 shows two prior art offset and nested silent chains.

FIG. 5 shows two nested chains incorporating tabs of the present invention.

FIG. 6 shows two chains incorporating tabs of the present invention.

FIG. 7A shows a front view of a tabbed guide link plate in an embodiment of the present invention.

FIG. 7B shows a side view of the guide link plate of FIG. 7A.

FIG. 8A shows a front view of another tabbed guide link plate in an embodiment of the present invention.

FIG. 8B shows a side view of the guide link plate of FIG. 8A.

FIG. 9 shows a triple chain with randomized tabs in an embodiment of the present invention.

FIG. 10A shows a front view of a first tabbed inverted tooth link in an embodiment of the present invention.

FIG. 10B shows a side view of the inverted tooth link plate of FIG. 10A.

FIG. 11 shows a second tabbed inverted tooth link in an embodiment of the present invention.

FIG. 12 shows a third tabbed inverted tooth link in an embodiment of the present invention.

FIG. 13 shows a guide link for a rocker joint chain.

FIG. 14 shows a phased chain assembly incorporating pin extensions in an embodiment of the present invention.

FIG. 15 shows an alternate guide link for a rocker joint chain.

FIG. 16 shows a preload design for the embodiment of FIG. 14.

FIG. 17 shows a preload design for the embodiment of FIG. 15.

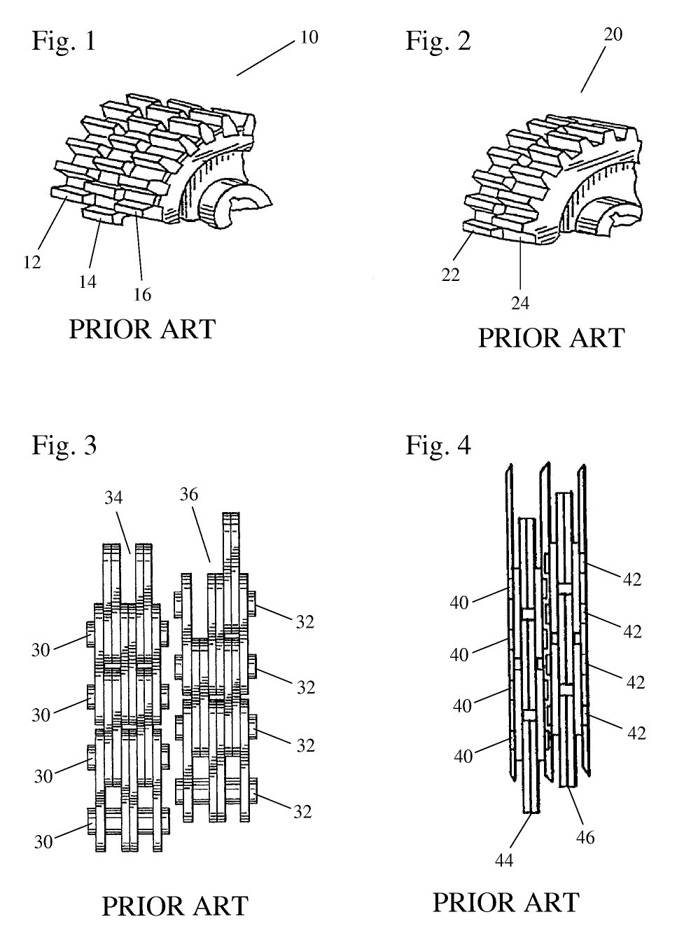

### DETAILED DESCRIPTION OF THE INVENTION

A first chain of the present invention includes at least one extension extending from the chain such that it contacts a neighboring chain to inhibit backbending inward of the first chain, thereby reducing resonance of the first chain. The extension also prevents the second chain from moving outward from a straight line position to set up a resonance vibration. In one embodiment, the extension is a tab extending from a link plate. In another embodiment, the extension is a pin extending past the guide link.

The extension extends laterally in a direction parallel to the chain pins and pin apertures and perpendicular to the direction of travel of the chain. Since the chains are physically out of phase with one another in terms of articulation, the vibration of the two chains is likely to be out of phase as well. When one chain tries to move inward, the other chain remains straight or is moving outward. The interconnecting extensions thus restrict the motion of the two chains from developing a large oscillation that can result in tension fluctuations in the tight chain strands and subsequent noise.

Although the present invention is preferably used in a phased chain assembly, the invention may be used in any multichain system where at least two chains engage at least two rows of sprocket teeth on a common shaft. The two rows of sprocket teeth may be on a common sprocket or on separate sprockets mounted to rotate together on the common shaft.

Although a phased chain assembly of the present invention preferably includes a silent chain, the invention may include a roller chain or bush chain within the spirit of the present invention. Conventional silent chains typically include both guide link plates and inverted tooth link plates joined together by pins. The guide link plates are positioned on the outside edges of alternate sets of link plates. The guide link plates typically act to position the chain laterally on the sprocket. Guide link plates typically do not mesh with the sprocket. Although a tab extending from a guide link plate is preferred, a tab may extend from either a guide link plate or an inverted tooth link plate within the spirit of the present invention.

In an embodiment of the present invention, a tab extends from an element of a first chain and contacts a second chain in a phased chain system such that the tab reduces resonance of the second chain. The tab preferably extends from the top portion of a link plate to contact the top portion of at least one link plate on the back side of the second chain. Preferably, another tab extends from an element of the second chain and contacts the first chain to reduce resonance in the first chain. The tabs snub the motion of the mating chain to inhibit resonance. In a preferred embodiment, the tab extends at an angle toward the adjacent chain to provide a slight preload to the adjacent chain. The tabbed elements are preferably ordered in a random sequence in a row of the chain. The first chain and the second chain may be physically attached to each other or separate. The first chain and the second chain are preferably inverted tooth chains. The chains are further preferably pin and rocker joint chains. The present invention is especially beneficial for rocker joint chains, since these chains have low losses and are more likely to require snubbing to prevent resonance than conventional inverted tooth chains with single round pins.

Randomization is preferably used to help break up resonance. In one embodiment, identical tabbed link plates are randomly placed in a row of at least one of the chains. In another embodiment, the location of the tab on the link plates varies to create a randomized pattern of tabbed guide link plates in a row of the chain. Untabbed links may also be included in the randomized row. In another embodiment, extended pins are randomly placed along the length of at least one of the chains. As used herein, “randomly”, “randomization”, and “random sequence” refer to any method of creating a sequence of two or more components along the length of a chain including, but not limited to, a computer-generated sequence or a predetermined sequence, such as a predetermined sequence based on noise simulation testing.

In a Gemini chain with interlocking guide link plates of the present invention, the tabs or extended pins contact the adjacent chain and prevent resonance motion from starting in the adjacent chain. In a preferred embodiment, the tabs or extended pins are oriented at an angle toward the adjacent chain to provide a slight preload with the adjacent chain. Increased tension straightens out the chain, which increases the preload on the neighboring chain.

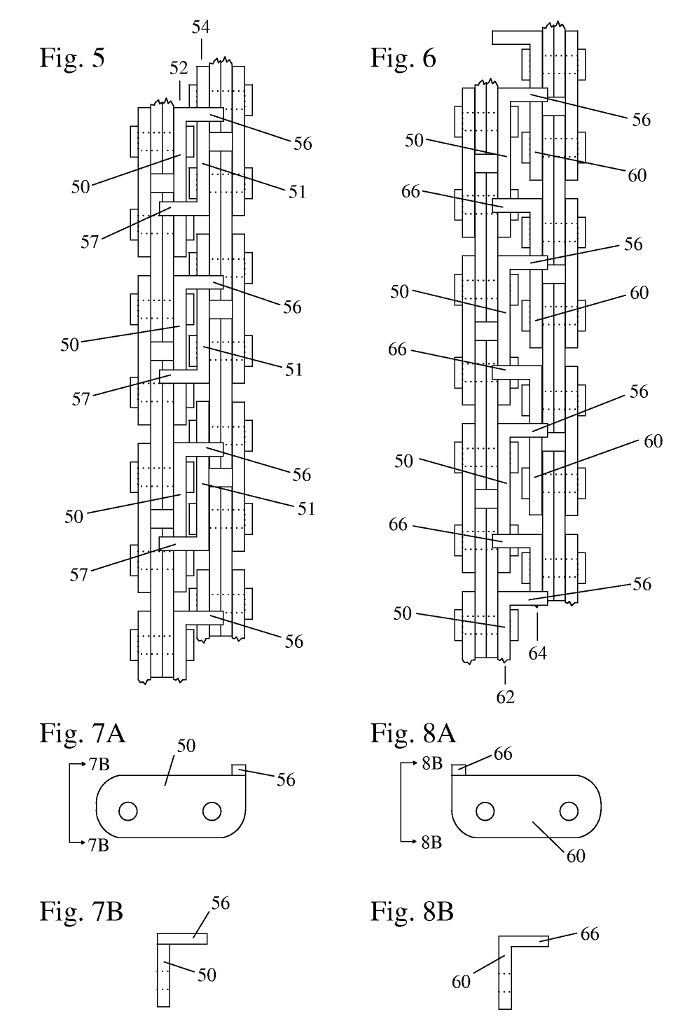

Referring to FIG. 5, the nested double chains are offset by a half pitch and include tabbed guide link plates in an embodiment of the present invention. In this embodiment, the tabbed guide link plates 50 extend from the right guide row 52 of the left chain to contact the top of the right chain to reduce resonance in the right chain. Similar tabbed guide link plates 51 extend from the left guide row 54 of the right chain to contact the top of the left chain and reduce resonance in the left chain. In this embodiment, the tabs 56, 57 extend from the ends of the guide link plates 50, have widths and heights similar to the width of the guide link plates, and extend past the neighboring guide row 52, 54 and over the neighboring non-guide row. In this embodiment, the tabbed guide link plates 50, 51 are substantially identical.

Referring to FIG. 6, the double chain is not nested, and the chains are offset by about a quarter pitch in an embodiment of the present invention. The tabbed guide link plates 50 extend from the right guide row 62 of the left chain to contact the top of the right chain to reduce resonance in the right chain. Mirror-image tabbed guide link plates 60 extend from the left guide row 64 of the right chain to contact the top of the left chain to reduce resonance in the left chain. In this embodiment, the tabs 56, 66 extend from the ends of the guide link plates 50 and have widths and heights similar to the width of the guide link plates. Although the tabs 56, 66 have the same length as in FIG. 5, since the chains are farther apart, the tabs 56, 66 only extend just past the neighboring guide row 52, 54.

The tabbed guide link plates 50, 60 of FIG. 5 and FIG. 6 are shown in front views and side views in FIG. 7A, FIG. 7B, FIG. 8A, and FIG. 8B, respectively. In these embodiments, the top edge of the guide link plates is at the same height as the top edge of the inverted tooth link plates in the assembled chains.

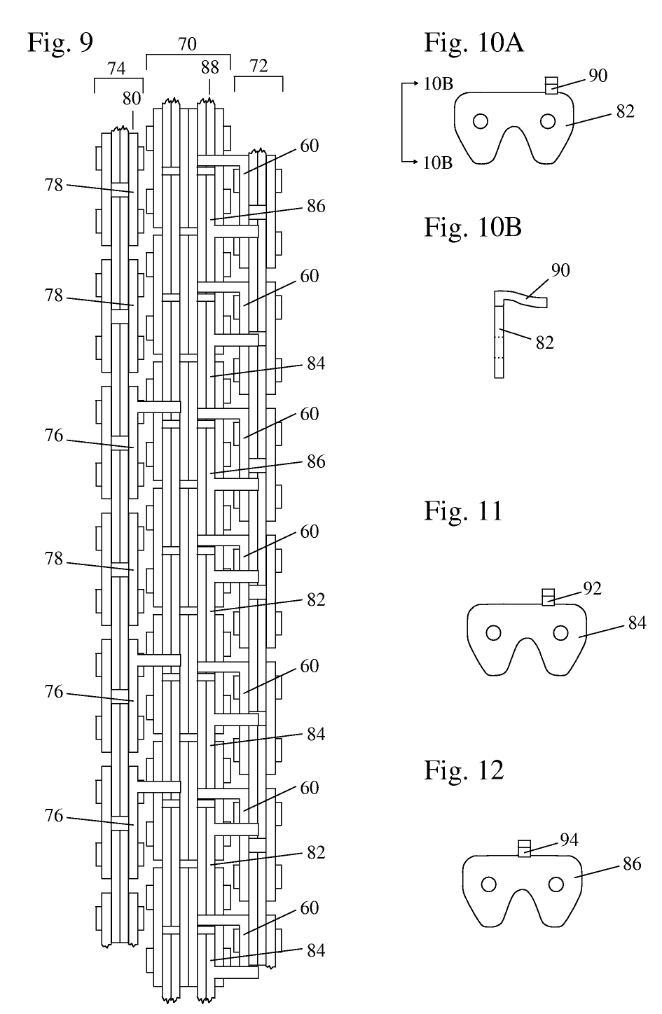

Referring to FIG. 9, a triple chain has chains offset by approximately one-third pitch and is intended to be illustrative of variations within the spirit of the present invention. Neighboring chains 70, 72 may have cross-contacting tabs to reduce resonance in both chains, or one chain 74 may contact its neighbor 70 to reduce resonance in the neighbor 70 without a cross-contact. A center chain 70 may be contacted on both sides by its neighboring chains 72, 74. In FIG. 9, tabs from the left chain 74 and the right chain 72 contact the center chain 70, while tabs from the center chain 70 only contact the right chain. Any type of chain lacing may be used as well as any type of link plate shape within the spirit of the present invention. In FIG. 9, the outer chains 72, 74 have a different lacing than the center chain 70.

Randomization of the sequence of tabbed link plates may be accomplished in at least two different ways. In a first embodiment, tabbed link plates 76 are randomly dispersed with untabbed link plates 78 in a row of the chain. Randomization of the sequence breaks up the regular interval of impact between the tabs and the neighboring chain, which allows the tabs to reduce resonance more effectively. The sequence of link plates may be randomized by any method of creating a random sequence or by a predetermined sequence, but the sequence is preferably predetermined based on noise simulation testing. In FIG. 9, the tabbed link plates 76 and untabbed link plates 78 are randomly sequenced in the guide row 80 of the left chain 74, and the tabbed link plates 76 are substantially identical. In a second embodiment, at least two different tabbed link plates 82, 84, 86 are placed in a random sequence in a row, where each link plate has the tab located at a different position along its length. The different tabbed link plates may also be randomly sequenced with untabbed link plates. Again, the sequence of link plates may be randomized by any method of creating a random sequence or by a predetermined sequence, but the sequence as well as the positions of the tabs is preferably predetermined based on noise simulation testing. In FIG. 9, three tabbed link plates 82, 84, 86 are randomly sequenced in a non-guide row 88 on the right side of the center chain 70.

Tabbed link plates of the present invention may be found in either a guide row 80 or a non-guide row 88. Tabbed link plates may be either guide link plates 50, 60 or inverted tooth link plates 82, 84, 86. The tabbed inverted tooth link plates 82, 84, 86 of FIG. 9 are shown from a front view in FIG. 10A, FIG. 11, and FIG. 12, respectively.

In yet another embodiment of the present invention, instead of extending straight out perpendicular to the link plate body, the tabs 90, 92, 94 slant downward as shown in FIG. 10A and FIG. 10B. The bottoms of the far tips of the tabs 90, 92, 94 preferably extend below the plane of the top edge of their link plate bodies 82, 84, 86, respectively, such that these tabs provide a slight preload with the adjacent chain. Alternatively, the tabs may extend straight out from the link plate bodies, such as shown in FIG. 7 and FIG. 8, with the preload being provided by adjusting the contact surface of the neighboring chain slightly such that when the neighboring chains are lined up, the tab overlaps the top of the contact surface. Thus, in practice, the chains are at a slight angle with very light tension, but the chains are forced to straighten out under increased tension such that the tab presses on the contact surface to provide the preload to the neighboring chain.

Although the tabs of FIG. 7, FIG. 8, and FIG. 10 have similar dimensions, other tab designs may be used within the spirit of the present invention. The tabs are preferably designed such that they do not substantially change the stiffness of their respective link plate bodies when the tabbed link plates are incorporated into a chain. Thus, there is a preferable range of tab sizes between one that makes the link plate too stiff and one that is too flexible to reduce resonance effectively.

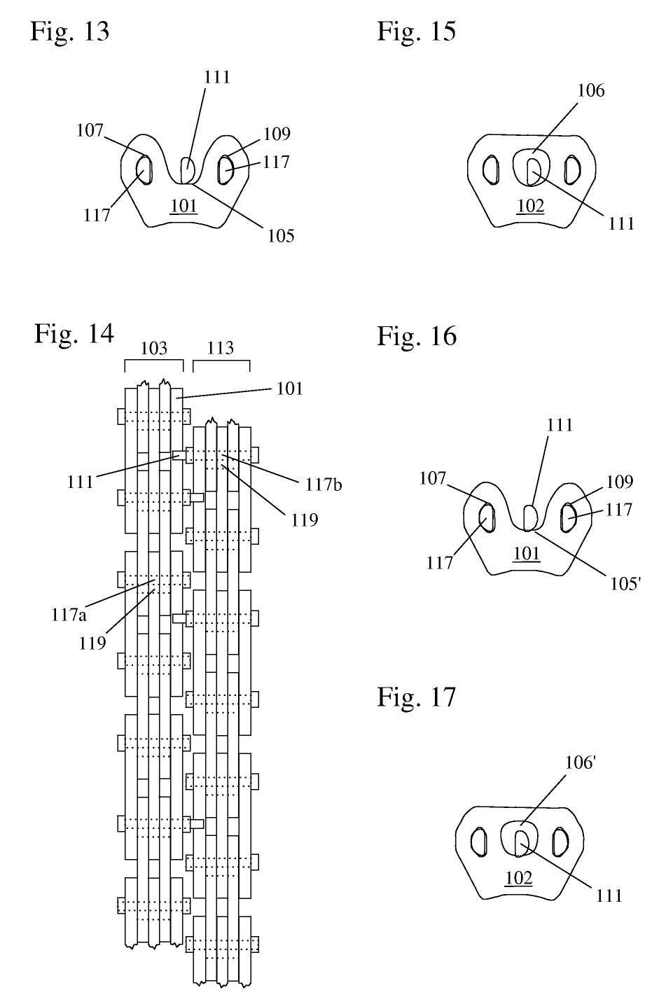

In another embodiment of the present invention, a pin, rather than a tab, extends from a first chain such that it contacts a second chain to inhibit backbending inward of the first chain, thereby reducing resonance of the first chain. The pin also prevents the second chain from moving outward from a straight line position to set up a resonance vibration. The pin contacts the second chain in an opening in a guide link of the second chain to snub the motion of the second chain. The opening may be a window with upper and lower surfaces or a valley such as the one that exists in an ET-type guide link 101 as shown in FIG. 13.

Referring to FIG. 13 through FIG. 15, in an embodiment of the present invention, at least one guide link 101 in a first chain 103 includes an opening 105 between its pin apertures 107, 109, and at least one pin 111 in a second chain 113 extends into the opening 105 in a phased chain assembly 115 to inhibit backbending of the first chain 103 and reduce resonance in the second chain 113 during operation of the chain and sprocket assembly. Alternatively, the valley opening 105 of FIG. 13 may be replaced with a hole opening 106 as shown in the guide link 102 of FIG. 15. The opening 106 is preferably large enough so that the pin 111 only contacts the bottom edge of the opening 106 and not the top edge during normal operation of the chain and sprocket assembly so that the pin 111 does not prevent movement of the second chain in the direction opposite the snubbing direction. The extending pin 111 achieves a similar effect to the tabs in the previous embodiments. The chains 103, 113 shown in FIG. 14 include a set of rocker pins 117, which extend into the guide links, and a set of second pins 119 that only pass through the inner links. The rocker pins 117 include rocker pins 117a of conventional length and rocker pins 117b of extended length to contact the neighboring chain.

As in the previous tabbed embodiments, the extending pins 111 may be placed at regular intervals along the chain or randomly located on the chain. Extending pins 111 may be on two neighboring chains to cross-contact their respective neighboring chains. As shown in FIG. 14, the neighboring chains are preferably phased by about a half-pitch so that the extending pins line up with the openings of the guide links of the neighboring chain, and only every other rocker pin lines up with an opening on the neighboring chain. Additionally, extending pins 111 may be used in combination with tabs in a phased chain assembly.

In contrast to the tabs, where preloading is preferably accomplished by angling the tab downward toward the neighboring chain, the extending pins 111 are preferably straight, even when preloading is desired. Instead, as shown in FIG. 16 and FIG. 17, the bottom of the openings 105′, 106′ are preferably raised such that when the neighboring chains are lined up as in FIG. 16 and FIG. 17, the extending pin 111 overlaps the bottom of the opening 105′, 106′. In practice, the chains are at a slight angle with very light tension, but the chains are forced to straighten out under increased tension such that the extending pins 111 press on the openings 105′, 106′ to provide the preload to the neighboring chains. Alternatively, the extending pins 111 may be angled to provide the pre-load to the neighboring chain, but from a manufacturing standpoint it is preferable to use straight pins.

In a chain and sprocket assembly of the present invention, the rows of sprocket teeth are preferably offset, but the present invention may also be used with multiple rows of in-phase sprocket teeth. The rows of sprocket teeth preferably have the same spacings, but the invention may also be used with chains having different pitches and multiple rows of sprocket teeth having different spacings.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A chain and sprocket assembly comprising:
a drive sprocket assembly having a plurality of first drive sprocket teeth and a plurality of second drive sprocket teeth, the first drive sprocket teeth and the second drive sprocket teeth being disposed in a parallel relationship and connected to a drive shaft to turn with the drive shaft;
a driven sprocket assembly having a plurality of first driven sprocket teeth and a plurality of second driven sprocket teeth, the first driven sprocket teeth and the second driven sprocket teeth being disposed in a parallel relationship and connected to a driven shaft to turn with the driven shaft;
a first chain assembly connecting the first drive sprocket teeth and the first driven sprocket teeth, the first chain assembly comprising:
a plurality of interleaved sets of first links comprising a plurality of first elements, the first elements comprising a plurality of first link plates and a plurality of first pins holding the first link plates together, the first link plates having apertures for receiving the first pins; and
a second chain assembly connecting the second drive sprocket teeth and the second driven sprocket teeth, the second chain assembly comprising:
a plurality of interleaved sets of second links comprising a plurality of second elements, the second elements comprising a plurality of second link plates and a plurality of second pins holding the second link plates together, the second link plates having apertures for receiving the second pins;
wherein at least one of the first elements is a damping first element comprising a first extension extending from a first element body such that the first extension contacts a back surface of the second chain assembly to reduce resonance in the second chain assembly by inhibiting movement of the second chain in a first direction during operation of the chain and sprocket assembly and the first extension allows movement of the second chain in a second direction opposite the first direction.

2. The chain and sprocket assembly of claim 1, wherein the at least one first element is an extended first pin of the plurality of first pins and comprises a first pin body and the first extension is a first pin extension extending from the first pin body.

3. The chain and sprocket assembly of claim 2, wherein at least one of the plurality of second elements is a contoured second link plate of the plurality of second link plates, the contoured second link plate having an opening between apertures such that the extended first pin inserts into the opening during operation of the chain and sprocket assembly.

4. The chain and sprocket assembly of claim 1, wherein the plurality of first elements comprises a plurality of the damping first element and a plurality of non-damping first elements, and the plurality of damping first elements and the plurality of non-damping first elements are located in a random sequence along a length of the first chain assembly.

5. The chain and sprocket assembly of claim 1, wherein the first extension and the back surface are formed such that the first extension provides a preload to the second chain assembly when the chain assemblies are under tension.

6. The chain and sprocket assembly of claim 1, wherein at least one of the second elements is a damping second element comprising a second extension extending from a second element body such that the second extension contacts the first chain assembly to reduce resonance in the first chain assembly during operation of the chain and sprocket assembly.

7. A chain and sprocket assembly comprising:
a drive sprocket assembly having a plurality of first drive sprocket teeth and a plurality of second drive sprocket teeth, the first drive sprocket teeth and the second drive sprocket teeth being disposed in a parallel relationship and connected to a drive shaft to turn with the drive shaft;
a driven sprocket assembly having a plurality of first driven sprocket teeth and a plurality of second driven sprocket teeth, the first driven sprocket teeth and the second driven sprocket teeth being disposed in a parallel relationship and connected to a driven shaft to turn with the driven shaft;
a first chain assembly connecting the first drive sprocket teeth and the first driven sprocket teeth, the first chain assembly comprising:
a plurality of interleaved sets of first links comprising a plurality of first link plates held together by a plurality of first pins, the first link plates having apertures for receiving the first pins; and
a second chain assembly connecting the second drive sprocket teeth and the second driven sprocket teeth, the second chain assembly comprising:
a plurality of interleaved sets of second links comprising a plurality of second link plates held together by a plurality of second pins, the second link plates having apertures for receiving the second pins;
wherein the first link plates comprise at least one tabbed first link plate comprising:
a first link plate body; and
a first tab extending from the first link plate body such that the first tab contacts the second chain assembly to reduce resonance in the second chain assembly during operation of the chain and sprocket assembly.

8. The chain and sprocket assembly of claim 7, wherein the first link plates comprise a plurality of the tabbed first link plate and the plurality of tabbed first link plates and a plurality of non-tabbed first link plates are located in a random sequence in a row of the first chain assembly.

9. The chain and sprocket assembly of claim 7, wherein the tabbed first link plate is selected from the group consisting of:
a) a guide link plate located in a guide row of the first chain assembly; and
b) an inverted tooth link plate located in a non-guide row of the first chain assembly.

10. The chain and sprocket assembly of claim 7, wherein the first link plates further comprise at least one tabbed second link plate comprising:
a second link plate body; and
a second tab extending from the second link plate body such that the second tab contacts the second chain assembly to reduce resonance in the second chain assembly during operation of the chain and sprocket assembly;
wherein the second tab extends from a lateral location on the second link plate body different than a lateral location on the first link plate body from which the first tab extends.

11. The chain and sprocket assembly of claim 10, wherein the first link plates comprise a plurality of the tabbed first link plates and a plurality of the tabbed second link plates and wherein the tabbed first link plates and the tabbed second link plates are located in a random sequence in a row of the first chain assembly.

12. The chain and sprocket assembly of claim 7, wherein the first tab extends at an angle toward the second chain assembly to contact the second chain assembly such that the first tab provides a preload to the second chain assembly.

13. The chain and sprocket assembly of claim 7, wherein the second link plates comprise at least one tabbed second link plate comprising:
a second link plate body; and
a second tab extending from the second link plate body such that the second tab contacts the first chain assembly to reduce resonance in the first chain assembly during operation of the chain and sprocket assembly.

14. A first chain assembly for a chain and sprocket assembly, the first chain assembly comprising:
a plurality of interleaved sets of first links comprising a plurality of first elements, the first elements comprising a plurality of first link plates and a plurality of first pins holding the first link plates together, the first link plates having apertures for receiving the first pins;
wherein at least one of the first elements is a damping first element comprising a first extension extending from a first element body such that during operation of the chain and sprocket assembly the first extension contacts a back surface of a second chain assembly to reduce resonance in the second chain assembly by inhibiting movement of the second chain in a first direction and the first extension permits the second chain to move in a second direction opposite the first direction.

15. The first chain assembly of claim 14, wherein the chain and sprocket assembly further comprises:
a drive sprocket assembly having a plurality of first drive sprocket teeth and a plurality of second drive sprocket teeth, the first drive sprocket teeth and the second drive sprocket teeth being disposed in a parallel relationship and connected to a drive shaft to turn with the drive shaft;
a driven sprocket assembly having a plurality of first driven sprocket teeth and a plurality of second driven sprocket teeth, the first driven sprocket teeth and the second driven sprocket teeth being disposed in a parallel relationship and connected to a driven shaft to turn with the driven shaft;
the first chain assembly connecting the first drive sprocket teeth and the first driven sprocket teeth; and
the second chain assembly connecting the second drive sprocket teeth and the second driven sprocket teeth, the second chain assembly comprising:
a plurality of interleaved sets of second links comprising a plurality of second elements, the second elements comprising a plurality of second link plates and a plurality of second pins holding the second link plates together, the second link plates having apertures for receiving the second pins.

16. The first chain assembly of claim 15, wherein the at least one first element is an extended first pin of the plurality of first pins and comprises a first pin body and the first extension is a first pin extension extending from the first pin body.

17. The first chain assembly of claim 16, wherein at least one of the plurality of second elements is a contoured second link plate of the plurality of second link plates, the contoured second link plate having an opening between apertures such that the extended first pin inserts into the opening during operation of the chain and sprocket assembly.

18. The first chain assembly of claim 15, wherein the plurality of first elements comprises a plurality of the damping first element and a plurality of non-damping first elements, and the plurality of damping first elements and the plurality of non-damping first elements are located in a random sequence along a length of the first chain assembly.

19. The first chain assembly of claim 15, wherein the first extension and the back surface are formed such that the first extension provides a preload to the second chain assembly when the chain assemblies are under tension.

20. A first chain assembly for a chain and sprocket assembly, the first chain assembly comprising:
a plurality of interleaved sets of first links comprising a plurality of first link plates held together by a plurality of first pins, the first link plates having apertures for receiving the first pins;
wherein the first link plates comprise at least one tabbed first link plate comprising:
a first link plate body; and
a first tab extending laterally from the first link plate body of the first chain assembly.

21. The first chain assembly of claim 20, wherein:
when the chain and sprocket assembly further comprises:
a drive sprocket assembly having a plurality of first drive sprocket teeth and a plurality of second drive sprocket teeth, the first drive sprocket teeth and the second drive sprocket teeth being disposed in a parallel relationship and connected to a drive shaft to turn with the drive shaft;
a driven sprocket assembly having a plurality of first driven sprocket teeth and a plurality of second driven sprocket teeth, the first driven sprocket teeth and the second driven sprocket teeth being disposed in a parallel relationship and connected to a driven shaft to turn with the driven shaft;
the first chain assembly connecting the first drive sprocket teeth and the first driven sprocket teeth; and
a second chain assembly connecting the second drive sprocket teeth and the second driven sprocket teeth, the second chain assembly comprising:
a plurality of interleaved sets of second links comprising a plurality of second link plates held together by a plurality of second pins, the second link plates having apertures for receiving the second pins;
the first tab extends from the first link plate body such that the first tab contacts the second chain assembly to reduce resonance in the second chain assembly during operation of the chain and sprocket assembly.

22. The first chain assembly of claim 21, wherein the first link plates comprise a plurality of the tabbed first link plate and the plurality of tabbed first link plates and a plurality of non-tabbed first link plates are located in a random sequence in a row of the first chain assembly.

23. The first chain assembly of claim 21, wherein the first link plates further comprise at least one tabbed second link plate comprising:
a second link plate body; and
a second tab extending from the second link plate body such that the second tab contacts the second chain assembly to reduce resonance in the second chain assembly during operation of the chain and sprocket assembly;
wherein the second tab extends from a lateral location on the second link plate body different than a lateral location on the first link plate body from which the first tab extends.

24. The first chain assembly of claim 23, wherein the first link plates comprise a plurality of the tabbed first link plates and a plurality of the tabbed second link plates and wherein the tabbed first link plates and the tabbed second link plates are located in a random sequence in a row of the first chain assembly.

25. The first chain assembly of claim 21, wherein the first tab extends at an angle toward the second chain assembly to contact the second chain assembly such that the first tab provides a preload to the second chain assembly.
